(19) United States
(12) Patent Application Publication
(10) Pub. No.: US 2005/0190697 A1
(43) Pub. Date: Sep. 1, 2005

(54) Transmission control system using link aggregation

(76) Inventors: Masahiro Dohi, Yokohama (JP); Kazuyuki Inomoto, Yokohama (JP); Tetsuya Tahara, Yokohama (JP); Junichi Kugimiya, Yokohama (JP); Ichiro Tanaka, Yokohama (JP); Hiroshi Ohtsuru, Yokohama (JP)

Correspondence Address: KATTEN MUCHIN ROSENMAN LLP, 575 MADISON AVENUE, NEW YORK, NY, 10022-2585, US

(21) Appl. No.: 10/941,713

(22) Filed: Sep. 15, 2004

(30) Foreign Application Priority Data
Mar. 1, 2004 (JP) 2004-055911

(51) Int. Cl. H04L 1/00

(52) U.S. Cl. 370/235; 370/394

(57) ABSTRACT

A transmission apparatus unitizes a plurality of variable-length frames in units of predetermined size and sorts the unitized frames for each unit into each of a plurality of ports, thereby transmitting the sorted frames. A reception apparatus accumulates received frames in each port and collects the accumulated frames for each unit from each port.

### BACKGROUND OF THE INVENTION

1. Field of the Invention

The present invention relates to a transmission control system for controlling data transmission using link aggregation of handling a plurality of ports as a broadband port.

2. Description of the Related Art

In the data transmission using link aggregation, frames that are inputted on a transmission side a resorted into each port and these frames are unified into one on a reception side. However, the frame order on a reception side must be guaranteed (refer to, for example, patent documents 1, 2 and 3. Patent document 1: Japanese patent application laid-open disclosure No. 2001-086122, Patent document 2: Japanese patent application laid-open disclosure No. 2002-232427 and Patent document 3: Japanese patent application laid-open disclosure No. 2002-009866). In IEEE (Institute of Electrical and Electronics Engineers) 802.3ad, a link aggregation technology is standardized and a mechanism of guaranteeing the frame order on a reception side is described.

FIG. 1 shows a configuration example of the transmission control system with such a mechanism. The transmission control system of FIG. 1 comprises a transmission apparatus 1001 and a reception apparatus 1002 that are connected by three links 1003, 1004 and 1005.

The transmission apparatus 1001 includes an input buffer (packet buffer) 1011, a distributor 1012 and ports 1013, 1014 and 1015. The reception apparatus 1002 includes ports 1021, 1022 and 1023, a collector 1024 and an output buffer 1025.

Port numbers of the ports 1013, 1014 and 1015 on a transmission side are “1”, “2” and “3”, respectively, while port numbers of the port 1021, 1022 and 1023 on a reception side are “1”, “2” and “3”, respectively. The ports 1013, 1014 and 1015 on a transmission side are connected with the ports 1021, 1022 and 1023 on a reception side via the links 1003, 1004 and 1005, respectively.

Therefore, the links 1003, 1004 and 1005 are aggregated to a logic link (trunk) 1006 by aggregating the ports 1013, 1014 and 1015 on a transmission side to be handled as a broadband port while the ports 1021, 1022 and 1023 on a reception side are also aggregated to be handled as a broadband port.

In the transmission apparatus 1001, an inputted variable-length data frame is first accumulated in the input buffer 1011. Then, the distributor 1012 sorts the frames that are accumulated in the input buffer 1011 into each port for each flow that is specified by an IPSA (Internet Protocol Source address), an IPDA (Internet Protocol Destination Address) and a PortNo. (Port number), with inserting a marker at the change of flows.

A marker protocol that is used at this time is a slow protocol (Type=8809h) of the MAC (Media Access Control) sublayer of a data link layer (L2) and a marker to be inserted is a 128-byte fixed-length MAC frame with link restriction.

In the example of FIG. 1, frames that belong to flows of the following three types are accumulated in the input buffer 1011.
Flow A: A1, A2, A3
Flow B: B1, B2, B3
Flow C: C1, C2, C3

Frames A1, A2 and A3 of the flow A are transferred to a transmission queue (transmission buffer) of the port 1015, frame B1, B2 and B3 of the flow B are transferred to a transmission queue of the port 1014 and frames C1, C2 and C3 of the flow C are transferred to a transmission queue of the port 1013. At this time, markers 1031, 1032, 1033, 1034, 1035 and 1036 are inserted before the frames A1, A3, B1, B2, C1 and C2, respectively. The frames accumulated in the transmission queue of each port are sequentially transmitted to the reception apparatus 1002.

In the reception apparatus 1002, receivers (reception buffers) of the ports 1021, 1022 and 1023 receive the frames transmitted from the transmission apparatus 1001. The collector 1024 removes the markers out of the frames accumulated in the receiver of each port and sequentially transfers the remaining frames to the output buffer 1025 provided at a subsequent stage thereof.

When the collector 1024 detects a marker, it returns a marker response 1037 to the transmission apparatus 1001 and the distributor 1012 of the transmission apparatus 1001 sorts frames of the input buffer 1011 into new ports with receipt of the marker response 1037 as trigger.

At the time of sorting frames on a transmission side in such a transmission control system, the passing of frames must be prevented in order to guarantee a frame order in the same flow. For this reason, even if a volume of incoming data flow exceeds a bandwidth allocated to a certain particular port (for example, the port 1013), a frame of the flow cannot be sorted into other ports. Accordingly, frames overflowed in the port 1013 must be abandoned although there is a room in other ports (for example, the port 1015) so that the merit of aggregation of a plurality of ports is not fully utilized.

Therefore, it is conceivable as a method of preventing such an overflow that a flow and a transmission port are related by using a look-up table (data table for identification) as shown in the patent document 2. In this method, several physical links of a logical link are aggregated to a link exclusive for particular traffic and a sub-logical link is assigned to the thus-aggregated physical links. In this way, flows can be further minutely classified and sorted into each port so that the occurrence probability of an overflow becomes low.

Another method of preventing the overflow is to increase a capacity of the transmission queue of each port. The larger the capacity of a transmission queue becomes, the lower the occurrence probability of the overflow becomes.

There is the following problem, however, in the above-mentioned conventional transmission control systems.

In such conventional methods of preventing the overflow of a port, a large-scale look-up table for further minutely classifying flows or a large-capacity transmission queue are required. However, it is difficult to entirely prevent the occurrence of the overflow in the case where the transmission rate slants even if such a table and such a queue are accommodated. Since a transmission rate differs for each port, a band cannot be always utilized effectively. Therefore, the improvement of a wire speed cannot be expected.

### SUMMARY OF THE INVENTION

The object of the present invention is to provide a transmission control system of preventing the overflow of a port and of effectively using a band without using a large-scale look-up table or a large-capacity transmission queue.

A transmission apparatus in the transmission control system of the present invention comprises a sort device and a transmission device and it transmits, using link aggregation of handling a plurality of ports as a broadband port, data accumulated in those ports. At this time, the sort device unitizes a plurality of variable-length frames in units of a predetermined size and sorts the frames for each unit into each of the plurality of ports, while the transmission device transmits the frames for each unit to a link connected to each port.

A reception apparatus in the transmission control system of the present invention comprises a reception device and a collection device. The apparatus accumulates received data in a plurality of ports using link aggregation of handling a plurality of ports as one broadband port. At this time, the reception device receives a plurality of length-variable frames that are unitized in units of a predetermined size from a link connected to each port and it accumulates the received frames in the port, while the collection device collects frames for each unit from the plurality of ports.

### DESCRIPTION OF THE DRAWINGS

FIG. 1 is a block diagram of a conventional transmission control system;

FIG. 2A is a block diagram showing the principles of a transmission apparatus and a reception apparatus of the present invention;

FIG. 2B is a block diagram of the first transmission control system;

FIG. 3 is a flowchart of the operations of a distributor;

FIG. 4 is a flowchart of the operations of the first marker multiplex unit;

FIG. 5 is a flowchart of the operations of the first marker demultiplex unit;

FIG. 6 is a flowchart of the operations of a collector;

FIG. 7 a block diagram of the second transmission control system;

FIG. 8 is a flowchart of the operations of the second marker multiplex unit; and

FIG. 9 is a flowchart of the operations of the second marker demultiplex unit.

### DESCRIPTION OF THE PREFERRED EMBODIMENTS

The following is the detailed explanation about the preferred embodiment of the present invention referring to the drawings.

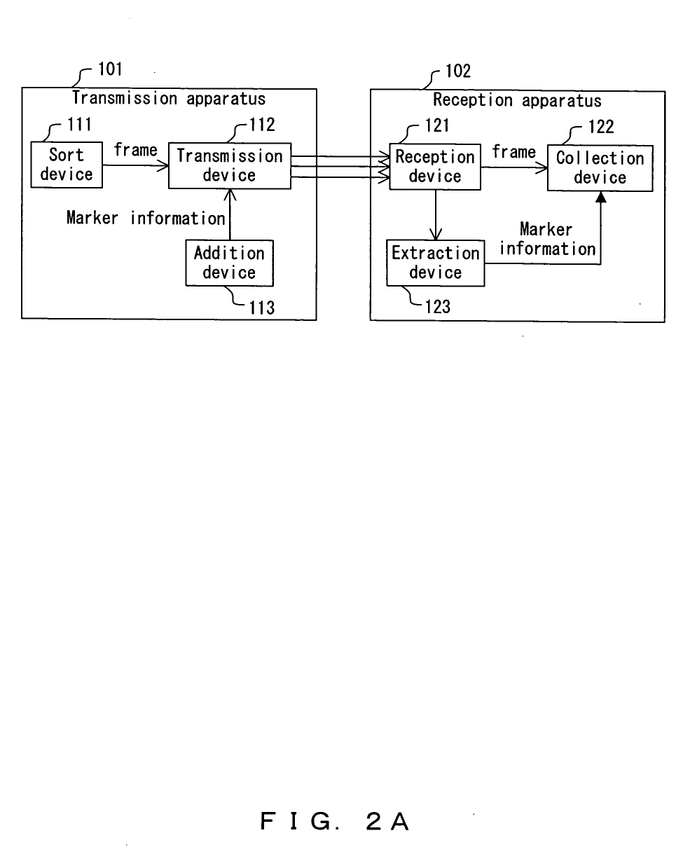

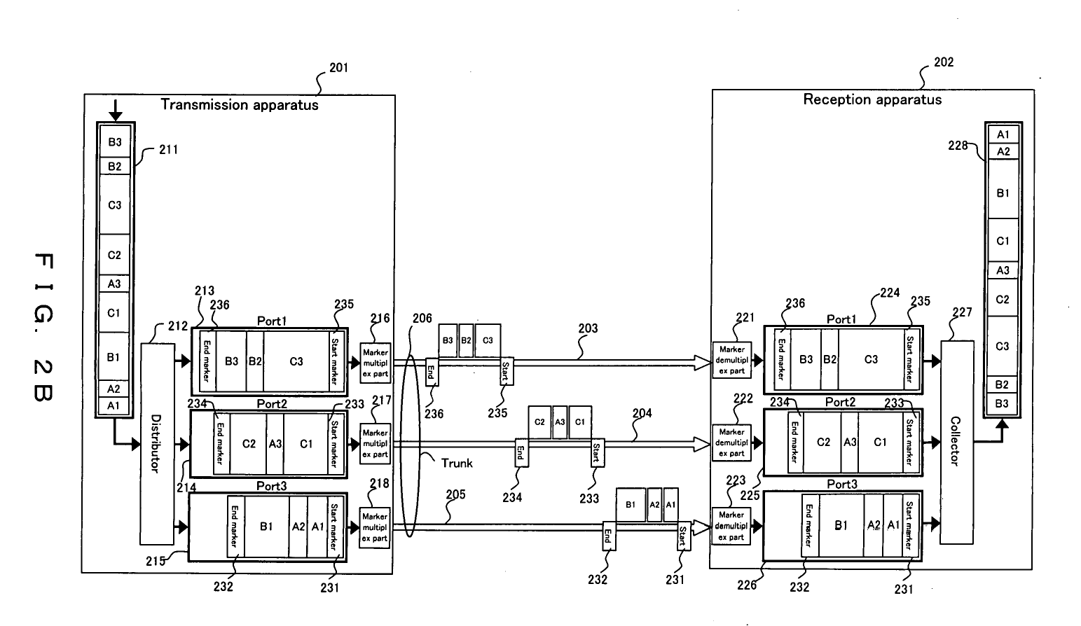

FIG. 2A is a block diagram showing the principles of a transmission apparatus and a reception apparatus in the transmission control system of the present invention.

In the first aspect of the present invention, a transmission apparatus 101 comprises a sort device 111 and a transmission device 112. Using link aggregation of handing a plurality of ports as one broadband port, the apparatus transmits the data accumulated in these ports. At this time, the sort device 111 unitizes a plurality of variable-length frames in units with a predetermined size and sorts the plurality of the frames for each unit into the respective ports, while the transmission device 112 transmits frames for each unit to a link connected to each port.

In the first aspect, a reception apparatus 102 comprises a reception device 121 and a collection device 122. The apparatus accumulates received data in a plurality of ports using link aggregation of handling a plurality of ports as one broad band port. At this time, the reception device 121 receives a plurality of variable-length frames that are unitized in units with a predetermined size from a link connected to each port and it accumulates the received frames in the port. The collection device 122 collects frames for each unit from each of the plurality of ports.

A plurality of frames to be transmitted is unitized by the sort device 111 on a transmission side and units with a predetermined size a regenerated. Then, each unit is sorted into each port and the sorted units are stored in the ports. Thus, the frames that are accumulated for each unit in each port are transmitted to each link by the transmission device 112. The transmitted frames are received by the reception device 121 on a reception side and the received frames are accumulated for each unit in each port. Then, the accumulated frames are collected for each unit from each port by the collection device 122.

In the second aspect of the present invention, the transmission apparatus 101 in the first aspect further comprises an addition device 113 adding marker information including a sequence number to each unit. The sort device 111 sorts frames that belong to each unit into each port, while sequentially changing a plurality of ports according to the sequence numbers.

In the second aspect of the present invention, the reception apparatus 102 in the first aspect further comprises an extraction device 123 extracting the marker information added to each unit. The collection device 121 collects frames that belong to each unit from each port, while sequentially changing a plurality of ports according to the sequence numbers included in the marker information.

The marker information is added to each unit to be transmitted by the addition device 113 on a transmission side. Then, ports to be sorted are changed by the sort device 111 according to the sequence numbers that are included in the marker information. The marker information added to each unit is transmitted by the transmission device 112 together with the frames that belong to each unit. The transmitted marker information is received together with the frames by the reception device 121 on a reception side and extracted by the extraction device 123. Then, the ports that are collection sources are changed by the collection device 121 according to the sequence numbers included in the extracted marker information.

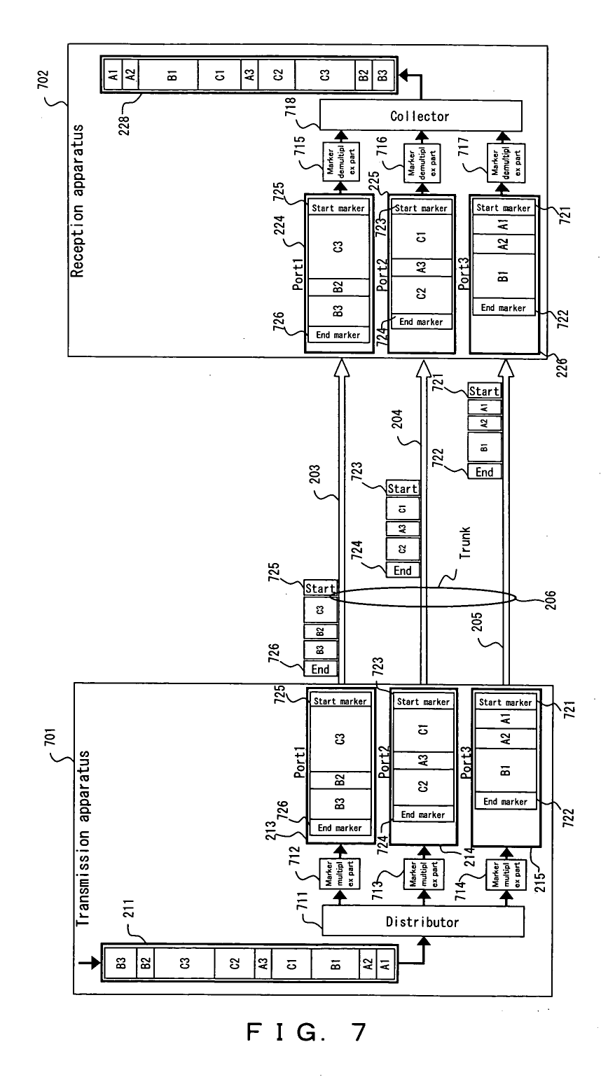

The sort device 111 corresponds to, for example, a distributor 212 of FIG. 2B or a distributor 711 of FIG. 7 that are described later. The transmission device 112 corresponds to, for example, ports 213, 214 and 215 and marker multiplex parts 216, 217 and 218 of FIG. 2B, or marker multiplex parts 712, 713 and 714 and ports 213, 214 and 215 of FIG. 7. The addition device 113 corresponds to, for example, a distributor 212 of FIG. 2B or marker multiplex parts 712, 713 and 714 of FIG. 7.

The reception device 121 corresponds to, for example, marker demultiplex parts 221, 222 and 223 and ports 224, 225 and 226 of FIG. 2B or ports 224, 225 and 226 and marker demultiplex parts 715, 716 and 717 of FIG. 7. The collection device 122 corresponds to, for example, a collector 227 of FIG. 2B or a collector 718 of FIG. 7. The extraction device 123 corresponds to, for example, the marker demultiplex parts 221, 222 and 223 of FIG. 2B or the marker demultiplex parts 715, 716 and 717 of FIG. 7.

According to the present invention, by sorting variable-length frames into each unit, the transmission rates of respective ports can be averaged. Therefore, the discard of frames in each port can be prevented and link aggregation effectively using a possessed band becomes possible, even if both a large-scale look-up table for relating a flow to a transmission port and a large-capacity transmission queue are not provided. Furthermore, since the frame order on a reception side is guaranteed by using marker information, the passing of a frame can be prevented.

In the following embodiment, frames are sorted into a transmission queue of each port provided on a transmission side not for each flow but for each predetermined size (unit size) that is used for unitizing frames. Accordingly, frames that belong to a plurality of different flows coexist in each unit. In this way, frames are rarely discarded due to the overflow on a transmission side since the transmission rates of respective ports are almost averaged. Therefore, the contents of a packet such as the IPSA, IPDA, PortNo., etc. need not be checked for the identification of a flow.

On a transmission side, a marker prepared by combining a “sequence number” and a “marker recognition pattern” is added to a frame and the frame is transmitted to a reception side. On the reception side, the order of unitized frames can be recognized using the markers that are added to the frames. Therefore, the frames can be reassembled in the same order as that of a frame group that is inputted into the transmission side, thereby preventing the passing of frames.

FIG. 2B is a block diagram of a transmission control system of the first embodiment of the present invention. The transmission control system of FIG. 2B comprises a transmission apparatus 201 and a reception apparatus 202. These apparatuses are connected with three links 203, 204 and 205. These links are aggregated to a trunk 206.

The transmission apparatus 201 comprises an input buffer 211, the distributor 212, the ports 213, 214 and 215 and the marker multiplex parts 216, 217 and 218. The reception apparatus 202 comprises the marker demultiplex parts 221, 222 and 223, the ports 224, 225 and 226, the collector 227 and an output buffer 228.

Port numbers of the ports 213, 214 and 215 on the transmission side are “1”, “2” and “3”, respectively, while port numbers of the ports 224, 225 and 226 on the reception side are “1”, “2” and “3”, respectively.

The marker multiplex parts 216, 217 and 218 are provided at the subsequent stages of the ports 213, 214 and 215 on a transmission side, respectively. The marker demultiplex parts 221, 222 and 223 are provided at the previous stages of the port 224, 225 and 226 on a reception side, respectively. The marker multiplex parts 216, 217 and 218 are connected with the marker demultiplex parts 221, 222 and 223, respectively via the links 203, 204 and 205.

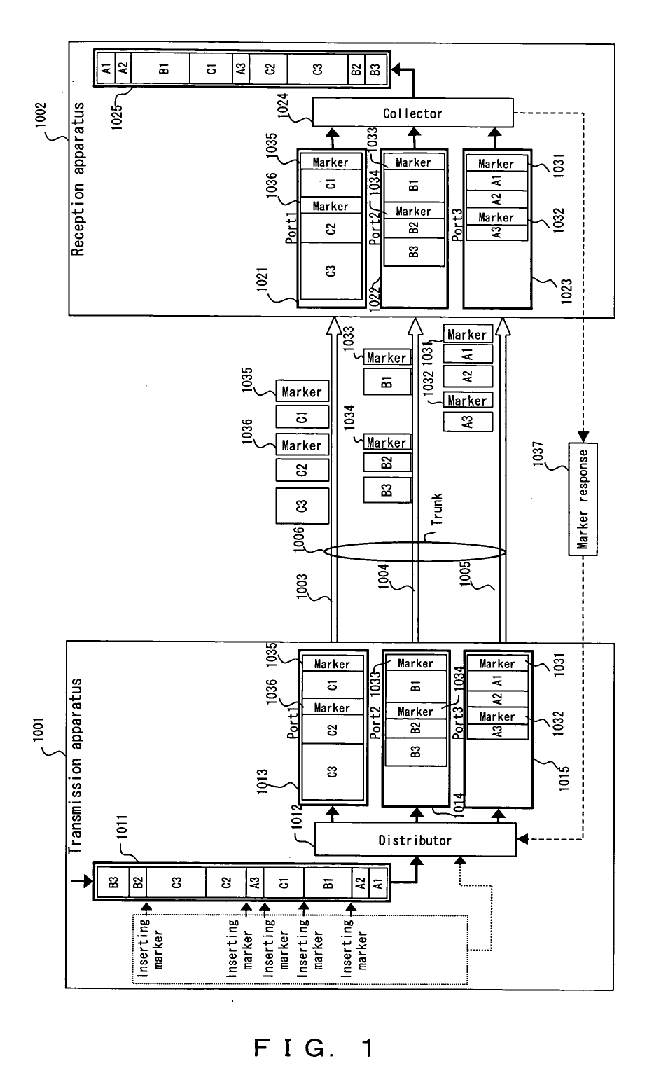

The inputted frames are first accumulated in the input buffer 211 in the transmission apparatus 201. In the example of FIG. 2B, the frames similar to those of FIG. 1 are accumulated in the input buffer 211.

Then, the distributor 212 sequentially transfers the frames accumulated in the input buffer 211 to, for example, a transmission queue of the port 215. At this time, the start marker in a unique format prepared by the combination of a “marker recognition pattern” and a “sequence number” is inserted before the frame to be transferred first.

A “marker recognition pattern” of the start marker is obtained by combining, for example, a “fixed pattern” that indicates a start and a “port number”. A “sequence number” indicates a frame order in the input buffer 211. In this case, the format of the start marker is “fixed pattern (start)”+“port number”+“sequence number”.

Here, the control data of “fixed pattern (start)”+“3”+“1” is inserted as the start marker 231 of a transmission queue of the port 215.

Subsequently, when the data frame amount that is transferred to and accumulated in a transmission queue of the port 215 exceeds a threshold of the predetermined unit size, the distributor 212 inserts the end marker with a unique format prepared by combining a “marker recognition pattern” and a “sequence number” after the frame that exceeds the threshold. In this way, the transfer to a transmission queue of the port 215 terminates.

The “marker recognition pattern” of the end marker is obtained by combining, for example, a “fixed pattern” that indicates an end and a “port number”. A “sequence number” indicates a frame order in the input buffer 211. In this case, the format of the end marker is “fixed pattern (end)”+“port number”+“sequence number”.

Here, the control data of “fixed pattern (end)”+“3”+“1” is inserted as the end marker 232 following the start marker 231 after the frames A1, A2 and B1 are transferred to a transmission queue of the port 215. In this way, the frames A1, A2 and B1 are unitized.

In addition, the threshold of a unit size is determined by the capacity and processing capability of a receiver of the port on a reception side.

Then, the distributor 212 sequentially transfers the frames accumulated in the input buffer 211 to, for example, a transmission queue of the port 214. At this time, similarly to the above-mentioned case of the port 215, frames are sequentially transferred after the start marker and when the data frame amount accumulated in the transmission queue exceeds the threshold of a unit size, the end marker is inserted after the frame that exceeds the threshold.

Here, the port number is “2”. The sequence number is incremented only by 1 and becomes “2”. Accordingly, a start marker 233 of a transmission queue of the port 214 becomes “fixed pattern (start)”+“2”+“2”+“2”. An end marker 234 becomes “fixed pattern (end)”+“2”+“2”. In this way, frames C1, A3 and C2 are unitized.

Next, the distributor 212 sequentially transfers the frames that are accumulated in the input buffer 211, for example, to a transmission queue of the port 213.

Here, the port number is “1”. The sequence number is further incremented by 1 and becomes “3”. Accordingly, a start marker 235 of a transmission queue of the port 213 becomes “fixed pattern (start)”+“1”+“3” while an end marker 236 becomes “fixed pattern (end)”+“1”+“3”. In this way, frames C3, B2 and B3 are unitized.

In this way, the distributor 212 repeats the sorting operation of frames in round-robin method in the order of port 215→port 214→port 213→port 215 while incrementing the sequence number of the marker by 1.

When a start/end marker and a frame group sandwiched between the markers are accumulated in a transmission queue of each port, frames are transmitted to the reception apparatus 202. At this time, the marker multiplex parts 216, 217 and 218 transmit a start/end marker while using a physical layer (L1) and utilizing a gap period between frames.

In the case where the traffic amount of an inputted frame decreases and the data frame amount accumulated in the transmission queue of a port does not reach the threshold of a unit size, the transmission of frames stops. Therefore, when a limited time has passed, the transmission apparatus 201 transmits frames to the reception apparatus 202 after it inserts an end marker into the transmission queue.

In the reception apparatus 202, receivers of the ports 224, 225 and 226 receive the frames transmitted from the transmission apparatus 201.

Since the start/end marker is transmitted in the gap period between frames, the marker is not recognized as an MAC frame on a reception side according to the configuration shown in FIG. 1. Therefore, the marker is discarded at the previous stage of each port on a reception side.

On the other hand, when the marker demultiplex parts 221, 222 and 223 at previous stages of the ports 224, 225 and 226 detect the marker recognition patterns from among the received data according to the configuration of FIG. 2B, they recognize “marker recognition pattern”+“sequence number” as a marker and transfer it to the receivers of the ports 224, 225 and 226.

Then, after the collector 227 checks the consistency of the start/end marker, it changes ports in the ascending order of the sequence numbers of the markers and sequentially transfers the received frames to the output buffer 228 at the subsequent stage.

Here, since the ports with the same port number send and receive frames between transmission and reception sides, ports are changed, for example, in the order of port 226→port 225→port 224→port 226. Instead of the ascending order of sequence numbers, ports can be changed in the descending order of port numbers included in the marker recognition pattern. In this case, however, ports are sequentially changed assuming that the port number next to “1” is “3”.

Also, the collector 227 has a protection circuit with a timer. In the case where a sequence number is omitted, the transmission of frames to the output buffer 228 is temporarily stopped until an expected sequence number is received. Meanwhile, the marker is terminated at the collector 227 without being transferred to the output buffer 228.

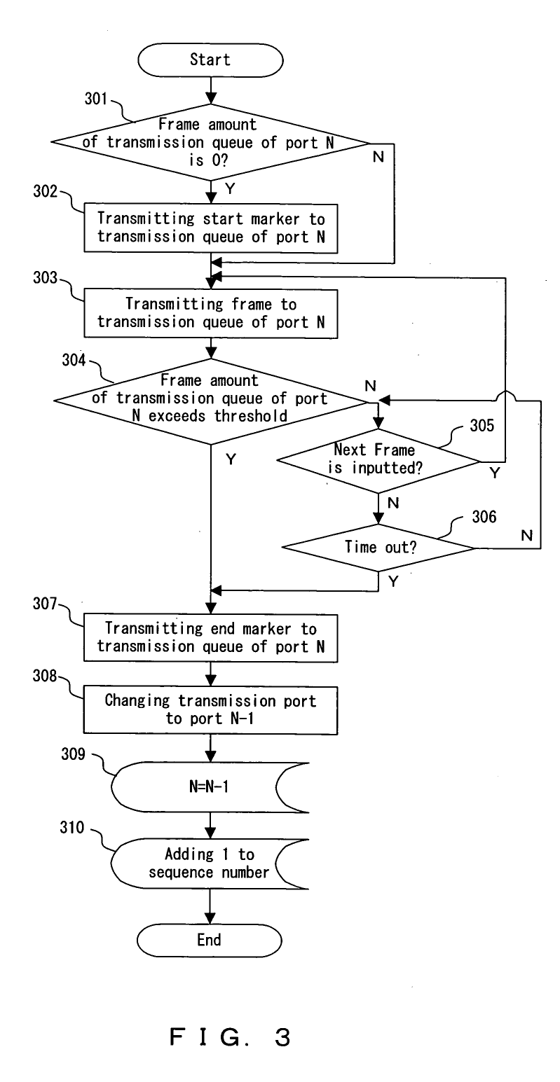

Next, the operations of the transmission control system of FIG. 2B are explained in detail while referring to FIGS. 3 through 6.

FIG. 3 is a flowchart of the operations of the distributor 212 of the transmission apparatus 201. In FIG. 3, a control variable N (1≦N≦total number of ports) indicates a port number of a destination port.

When a frame is inputted into the input buffer 211, the distributor 212 first checks whether or not the frame amount of a transmission queue of the port with a port number N is 0 (step 301). If the frame amount is 0, the distributor 212 transmits a start marker to a transmission queue of the port (step 302), then it transmits an inputted frame to the transmission queue (step 303). If the frame amount is not 0, the operation in step 303 is performed without transmitting the start marker.

Next, it is checked whether or not the frame amount of a transmission queue of the port with a port number N exceeds the threshold of a unit size (step 304). If the frame amount does not exceed the threshold, it is checked whether or not the next frame is inputted into the input buffer 211 (step 305). If the next frame is inputted, the operations in and after step 303 are repeated.

If the next frame is not inputted, it is checked whether or not a limited time has passed (step 306). If the limited time has not passed, operations in and after step 305 are repeated. If the limited time has passed, the distributor 212 transmits an end marker to the transmission queue of the port with a port number N (step 307), and it changes a sort destination to the port with a port number N−1 (step 308).

Then, “N=N−1” is set (step 309), “1” is added to the sequence number and operations terminate (step 310). In the case where the frame amount exceeds the threshold in step 304, the operations in and after step 307 are performed right away.

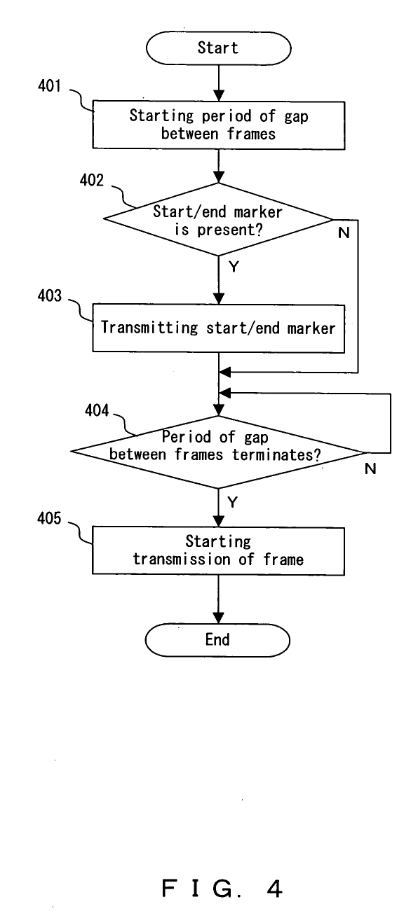

FIG. 4 is an operation flowchart of the marker multiplex parts 216, 217 and 218 of the transmission apparatus 201. When a previous frame is transmitted, a period of the gap between frames is started (step 401), the marker multiplex parts check whether or not the next transmission data stored in the transmission queue of a port is the start/end marker (step 402). If the next transmission data is the marker, this marker is transmitted to a link (step 403). At this time, a start marker of the next unit is transmitted following an end marker of the previous unit. If the next transmission data is not the marker, the operations in step 404 are directly performed.

Next, it is checked whether or not a period of the gap between frames terminates (step 404). If a period of the gap between frames has not terminated, the operations in step 404 are repeated. If a period of the gap between frames has terminated, transmission of the next frame starts (step 405).

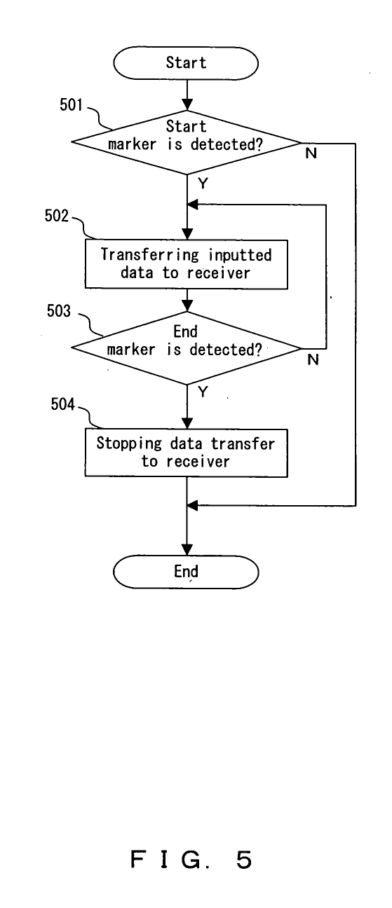

FIG. 5 is an operation flowchart of the marker demultiplex parts 221, 222 and 223 of the reception apparatus 202. When reception data is inputted from a link, the marker demultiplex part checks whether or not the start marker is detected from the reception data (step 501). If the start marker is detected, the inputted data is transferred to the receiver of a port (step 502). If the start marker is not detected, operations directly terminate.

Next, it is checked whether or not the end marker is detected from reception data (step 503). If the end marker is not detected, operations in and after step 502 are repeated. If the end marker is detected, the transfer of data to the receiver of a port is stopped (step 504).

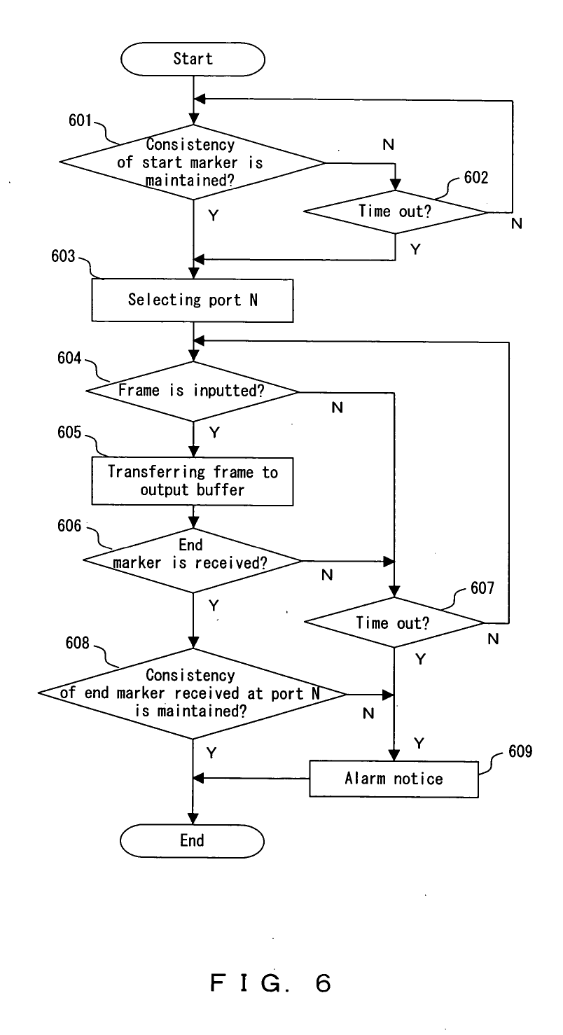

FIG. 6 is an operation flowchart of the collector 227 of the reception apparatus 202. In FIG. 6, a control variable N indicates the port number of a source port of reception data.

When the start marker is inputted from the receiver of a corresponding port, the collector 227 first checks the consistency of the start marker (step 601). In this consistency check, it is checked whether or not a sequence number of the start marker matches with the number next to the sequence number of an end marker that is inputted immediately before, whether or not the sequence number and the port number are correct, etc.

If the consistency of the start marker is maintained, the collector 227 selects a port corresponding to the port number N of the start marker (step 603), and checks whether or not a frame is stored in a receiver of the port (step 604).

If the consistency of the start marker is not maintained, it is checked whether or not a limited time has passed (step 602). When the limited time has not passed, the operations in and after step 601 are repeated. After the limited time has passed, operations in and after step 603 are performed.

If a frame is not stored in step 604, it is checked whether or not a limited time has passed (step 607). If the limited time has not passed, operations in and after step 604 are repeated. If the limited time has passed, an alarm is notified (step 609) and the operations terminate.

If a frame is stored in step 604, the frame is transferred to the output buffer 228. Then, it is checked whether or not the receiver of the port with a port number N receives the end marker (step 606). If the receiver of the port does not receive the end marker, the operations in and after step 607 are repeated.

When the receiver of the port with a port number N receives the end marker, the consistency of the end marker is checked (step 608). In this consistency check, it is checked whether or not a sequence number of the end marker matches with a sequence number of the start marker that is inputted immediately before, whether or not the sequence number and the port number are correct, etc.

When the consistency of the end marker is maintained, operations directly terminate. If the consistency of the end marker is not maintained, an alarm is notified (step 609) and operations terminate.

FIG. 7 is a block diagram of a transmission control system according to the second preferred embodiment of the present invention. The transmission control system of FIG. 7 comprises a transmission apparatus 701 and a reception apparatus 702.

The transmission apparatus 701 comprises the input buffer 211, a distributor 711, marker multiplex parts 712, 713 and 714, and the ports 213, 214 and 215. The reception apparatus 702 comprises the ports 224, 225 and 226, marker demultiplex parts 715, 716 and 717, a collector 718 and the output buffer 228. The ports 213, 214 and 215 on a transmission side are connected with the ports 224, 225 and 226 on a reception side via the links 203, 204 and 205, respectively.

The marker multiplex parts 712, 713 and 714 are provided at the previous stages of the ports 213, 214 and 215 on a transmission side, respectively. The marker demultiplex parts 715, 716 and 717 are provided at the subsequent stages of the ports 224, 225 and 226 on a reception side, respectively.

In the transmission apparatus 701, inputted frames are first accumulated in the input buffer 211. In the example of FIG. 7, frames similar to FIG. 2B are accumulated in the input buffer 211.

Next, the distributor 711 sequentially transfers frames that are accumulated in the input buffer 211 via, for example, the marker multiple part 714 to a transmission queue of the port 215. At this time, the marker multiplex part 714 inserts a start marker before the frame that is transferred first.

This start marker is a 128-byte fixed-length MAC frame with link restriction into which a “marker recognition pattern” and a “sequence number” are inserted. Similarly to the case of FIG. 2B, a “marker recognition pattern” of the start marker is obtained by combining, for example, a “fixed pattern” that indicates a start and a “port number”.

After that, when the data frame amount that is transferred to and accumulated in a transmission queue of the port 215 exceeds a threshold of the predetermined unit size, the marker multiplex part 714 inserts an end marker after the frame that exceeds the threshold. This causes the termination of transfer of frames to a transmission queue of the port 215.

Similar to the start marker, this end marker is a 128-byte fixed-length MAC frame with link restriction into which a “marker recognition pattern” and a “sequence number” are inserted. A “marker recognition pattern” of the end marker is obtained by combining, for example, a “fixed pattern” that indicates an end and a “port number” similarly to the case of FIG. 2B.

Similarly to the case of FIG. 2B, the threshold of the unit size is determined by the capacity and processing ability of the receiver of a port on a reception side.

Subsequently, the distributor 711 repeats the sort of frames in round-robin method in the order of port 215→port 214→port 213→port 215 while incrementing the sequence number of a marker by 1 similarly to the case of FIG. 2B.

In this way, the frames A1 through B3 are unitized similarly to the case of FIG. 2B and the start markers 721, 723 and 725 are inserted before the frames A1, C1 and C3, respectively. The end markers 722, 724 and 726 are inserted after the frames B1, C2 and B3, respectively.

When the frame group consisted from the start marker to the end marker is accumulated in a transmission queue of each port, the frames are transmitted to the reception apparatus 702. At this time, the ports 213, 214 and 215 transmit frames of the start/end markers using a data link layer.

In the reception apparatus 702, receivers of the ports 224, 225 and 226 receive the frames that are transmitted from the transmission apparatus 701. In this case, differently from the configuration of FIG. 2B, the start/end marker is transmitted as a MAC frame so that the marker can be directly received by a receiver of each port.

Then, the collector 718 receives the received frames via the marker demultiplex parts 715, 716 and 717. After the collector 718 checks the consistency of the start/end marker, it changes ports in the ascending order of the sequence numbers of markers and sequentially transfers the received frames to the output buffer 228 provided at the subsequent stage. Instead of the ascending order of sequence numbers, ports may be changed in the descending order of port numbers that are included in a marker recognition pattern.

In addition, the collector 718 has a protection circuit with a timer like the collector 227 of FIG. 2B and stops the transmission of frames to the output buffer 228 until the expected sequence number is received in the case where a sequence number is omitted. Incidentally, the marker is terminated at the collector 718 without being transferred to the output buffer 228.

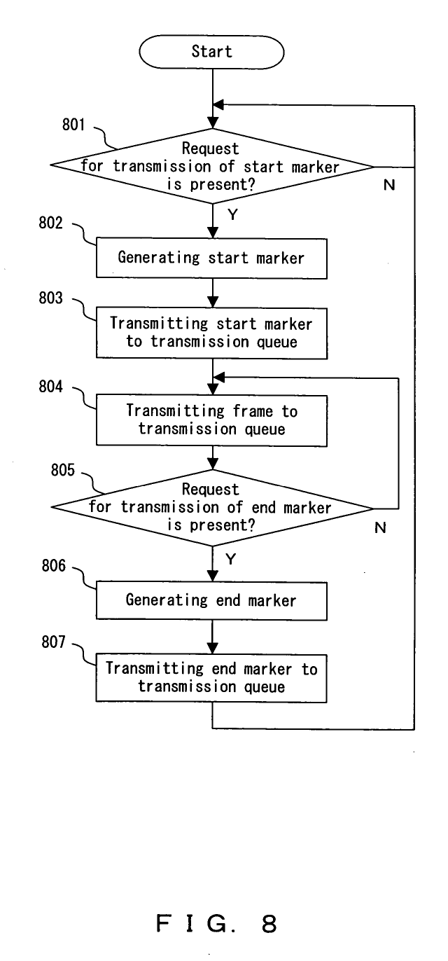

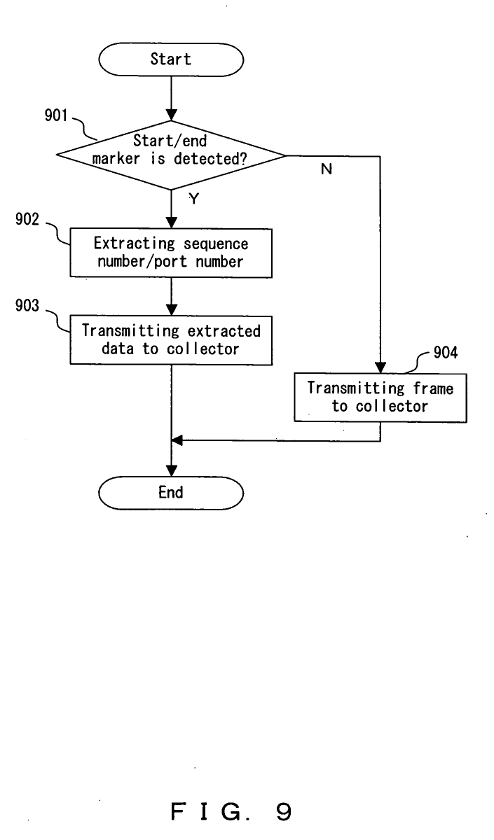

The following is the detailed explanation of the operations of the marker multiplex parts 712, 713 and 714 and the marker demultiplex parts 715, 716 and 717 of FIG. 7 in reference to FIGS. 8 and 9.

The operations of the distributor 711 and the collector 718 of FIG. 7 are basically similar to those that are shown in FIGS. 3 and 6, respectively. The distributor 711, however, transfers a request for the transmission of a start/end marker to each marker multiplex part, instead of transmitting a start/end marker to the transmission queue of each port. Also, the distributor 711 transmits frames to each marker multiplex part, instead of transmitting frames to the transmission queue of each port. The collector 718, on the other hand, receives the data of a reception frame from each marker demultiplex part instead of the receiver of each port.

FIG. 8 is an operation flowchart of the marker multiplex parts 712, 713 and 714 of the transmission apparatus 701. It is checked whether or not they receive the requests for transmission of start markers from the distributor 711 (step 801). Until they receive the transmission requests, they repeat the operations in step 801. When they receive the requests for transmission of start markers, they generate frames of start markers (step 802), transmit the frames to the transmission queues of ports (step 803), and transmit the frames (data frames) that are transferred from the distributor 711 to the transmission queues of ports (step 804).

Next, it is checked whether or not the requests for transmission of end markers are received from the distributor 711 (step 805). If the requests for transmission of end markers are not received, the operations in and after step 804 are repeated. When the requests for transmission of end markers are received, frames of the end markers are generated (step 806), the frames are transmitted to the transmission queues of ports (step 807), and the operations in and after step 801 are repeated.

FIG. 9 is an operation flowchart of the marker demultiplex parts 715, 716 and 717 of the reception apparatus 702. When reception frames are inputted via the receivers of ports, the marker demultiplex parts check whether or not the start/end markers are detected from the reception frames (step 901). If the start/end markers are detected, the parts extract both sequence numbers and port numbers from the detected markers (step 902), and transfer the extracted numbers to the collector 718 (step 903). If the start/end markers are not detected, the reception frames (data frame) are transmitted to the collector 718 (step 904).

In the above-mentioned embodiments of the present invention, the same port numbers are assigned to two corresponding ports on transmission and reception sides. However, the same port numbers not always have to be assigned to the corresponding two ports. In the case where port numbers are different on a reception side and on a transmission side, a table storing relation information between port numbers is prepared beforehand in a reception apparatus and a collector performs the operations of FIG. 6 referring to the table.

The number of ports on transmission and reception sides is not limited to three so that ports of which the number is any optional number equal to or more than two can be provided. Furthermore, it is not always necessary to use both a start marker and an end marker at the same time. Therefore, transmission control may be performed using only either of them.

The present invention is applicable not only to the transmission control among apparatuses connected via a communication network such as a LAN (Local Area Network), etc. but also to the transmission control among units provided in the same apparatus or among devices installed on the same board.

1. A transmission apparatus for, using link aggregation of handling a plurality of ports as a broadband port, transmitting data that is accumulated in the plurality of ports comprising:
a sort device unitizing a plurality of variable-length frames in units of predetermined size and sorting the unitized frames for each unit into each of the plurality of ports; and
a transmission device transmitting the frames to a link connected with each port.

2. The transmission apparatus according to claim 1, wherein
when an amount of frames accumulated in a transmission queue of each port exceeds a threshold of the predetermined size, said transmission device transmits the accumulated frames as a unit.

3. The transmission apparatus according to claim 1, wherein
in a case where an amount of frames accumulated in a transmission queue of each port does not exceed a threshold of the predetermined size, said transmission device transmits the accumulated frames as a unit after a limited time has passed.

4. The transmission apparatus according to claim 1, further comprising
an addition device adding marker information including a sequence number to each unit, wherein
said sort device sorts frames belonging to each unit into each port while sequentially changing the plurality of ports according to the sequence number.

5. The transmission apparatus according to claim 4, wherein
the marker information includes a marker recognition pattern.

6. The transmission apparatus according to claim 1, further comprising
an addition device adding to each unit start marker information indicating a start of the unit and end marker information indicating an end of the unit, wherein
said transmission device transmits data in an order of the start marker information, frames belonging to the unit and the end marker information.

7. The transmission apparatus according to claim 6, wherein
said transmission device transmits the start marker information and the end marker information utilizing a period of a gap between frames in a physical layer.

8. The transmission apparatus according to claim 6, wherein
said transmission device transmits the start marker information and the end marker information as a fixed-length control frame in a data link layer.

9. A reception apparatus for, using link aggregation of handling a plurality of ports as a broadband port, accumulating received data in the plurality of ports comprising:
a reception device receiving a plurality of variable-length frames that are unitized in units of predetermined size from a link connected with each port and accumulating the received frames in the port; and
a collection device collecting frames for each unit from each of the plurality of ports.

10. The reception apparatus according to claim 9, further comprising
an extraction device extracting marker information added to each unit, wherein
said collection unit collects frames belonging to each unit from each port while sequentially changing the plurality of ports according to sequence numbers included in the marker information.

11. The reception apparatus according to claim 10, wherein
the marker information includes a marker recognition pattern; and
said extraction device recognizes the marker information using the marker recognition pattern.

12. The reception apparatus according to claim 9, further comprising
an extraction device, wherein
said reception device receives data in an order of start marker information indicating a start of a unit, frames belonging to the unit and end marker information indicating an end of the unit;
said extraction device extracts the start marker information and the end marker information that are added to each unit; and
said collection unit collects frames belonging to each unit using the extracted start marker information and end marker information.

13. The reception apparatus according to claim 12, wherein
said reception device receives the start marker information and end marker information transmitted utilizing a period of a gap between frames in a physical layer.

14. The reception apparatus according to claim 12, wherein
the reception device receives the start marker information and end marker information transmitted as a control fixed-length frame in a data link layer.

15. A transmission method of, using link aggregation of handling a plurality of ports as a broadband port, transmitting data that is accumulated in the plurality of ports comprising:
unitizing a plurality of variable-length frames in units of predetermined size and sorting the unitized frames for each unit into each of the plurality of ports; and
transmitting the frames for each unit to a link connected with each port.

16. A reception method of, using link aggregation of handling a plurality of ports as a broadband port, accumulating received data in the plurality of ports comprising:
receiving a plurality of variable-length frames that are unitized in units of predetermined size from a link connected with each port;
accumulating the received frames in each port; and
collecting frames for each unit from each of the plurality of ports.

17. A transmission apparatus for, using link aggregation of handling a plurality of ports as a broadband port, transmitting data that is accumulated in the plurality of ports comprising:
sort means for unitizing a plurality of variable-length frames in units of predetermined size and sorting the unitized frames for each unit into each of the plurality of ports; and
transmission means for transmitting the sorted frames for each unit to a link connected with each port.

18. A reception apparatus for, using link aggregation of handling a plurality of ports as a broadband port, accumulating received data in the plurality of ports comprising:
reception means for receiving a plurality of variable-length frames that are unitized in units of predetermined size from a link connected with each port and accumulating the received frames in the port; and
collection means for collecting frames for each unit from each of the plurality of ports.
